(19) United States
(12) Patent Application Publication
(10) Pub. No.: US 2023/0218035 A1
(43) Pub. Date: Jul. 13, 2023

(54) Therapeutic Safety Shoe Assembly

(71) Applicant: Timika Walker, Decatur, GA (US)

(72) Inventor: Timika Walker, Decatur, GA (US)

(21) Appl. No.: 17/572,224

(22) Filed: Jan. 10, 2022

(51) Int. Cl. A43B 7/1455; A61H 23/02

(52) U.S. Cl. CPC A43B 7/146; A61H 23/0254; A61H 2201/165; A61H 2205/12

(57) ABSTRACT

A therapeutic safety shoe assembly for reducing foot fatigue includes a shoe that is wearable on a user's foot. The shoe has a sole, a heel and a toe, and a shield is integrated into the toe to protect the user's toes. A vibration unit is provided and the vibration unit is integrated into the shoe. The vibration unit vibrates the shoe when the vibration unit is turned on to massage the user's foot when the shoe is being worn. The vibration unit includes a heel element that is integrated into the heel of the shoe and the vibration unit includes a sole element that is integrated into the sole of the shoe.

### CROSS-REFERENCE TO RELATED APPLICATIONS

### Not Applicable

### STATEMENT REGARDING FEDERALLY SPONSORED RESEARCH OR DEVELOPMENT

### Not Applicable

### THE NAMES OF THE PARTIES TO A JOINT RESEARCH AGREEMENT

### Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### STATEMENT REGARDING PRIOR DISCLOSURES BY THE INVENTOR OR JOINT INVENTOR

### Not Applicable

### BACKGROUND OF THE INVENTION

### (1) Field of the Invention

The disclosure relates to safety shoe devices and more particularly pertains to a new safety shoe device for reducing foot fatigue. The device includes a steel toed shoe and a plurality of vibration units that are integrated into the steel toed shoe. In this way the steel toed shoe can massage a user's feet when the vibration units are turned on. The device includes a receiver that is in wireless communication with a personal electronic device for remotely controlling the vibration units.

### (2) Description of Related Art Including Information Disclosed Under 37 CFR 1.97 and 1.98

The prior art relates to safety shoe devices including a variety of methods of constructing a steel toed shoe. The prior art discloses a shoe shaped foot massager that can be worn on a user's foot. The prior art discloses a massaging shoe that includes vibration units that are integrated into a sole of a shoe for massaging a user's feet. The prior art discloses a foot massage physiotherapy plate that is integrated into footwear. The prior art discloses a massage slipper that includes vibration units and a remote control.

### BRIEF SUMMARY OF THE INVENTION

An embodiment of the disclosure meets the needs presented above by generally comprising a shoe that is wearable on a user's foot. The shoe has a sole, a heel and a toe, and a shield is integrated into the toe to protect the user's toes. A vibration unit is provided and the vibration unit is integrated into the shoe. The vibration unit vibrates the shoe when the vibration unit is turned on to massage the user's foot when the shoe is being worn. The vibration unit includes a heel element that is integrated into the heel of the shoe and the vibration unit includes a sole element that is integrated into the sole of the shoe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a right side phantom view of a therapeutic safety shoe assembly according to an embodiment of the disclosure.

FIG. 2 is a right side phantom view of an embodiment of the disclosure.

FIG. 3 is a back phantom view of an embodiment of the disclosure.

FIG. 4 is a front phantom view of an embodiment of the disclosure.

FIG. 5 is a top phantom view of an embodiment of the disclosure.

FIG. 6 is a bottom phantom view of an embodiment of the disclosure.

### DETAILED DESCRIPTION OF THE INVENTION

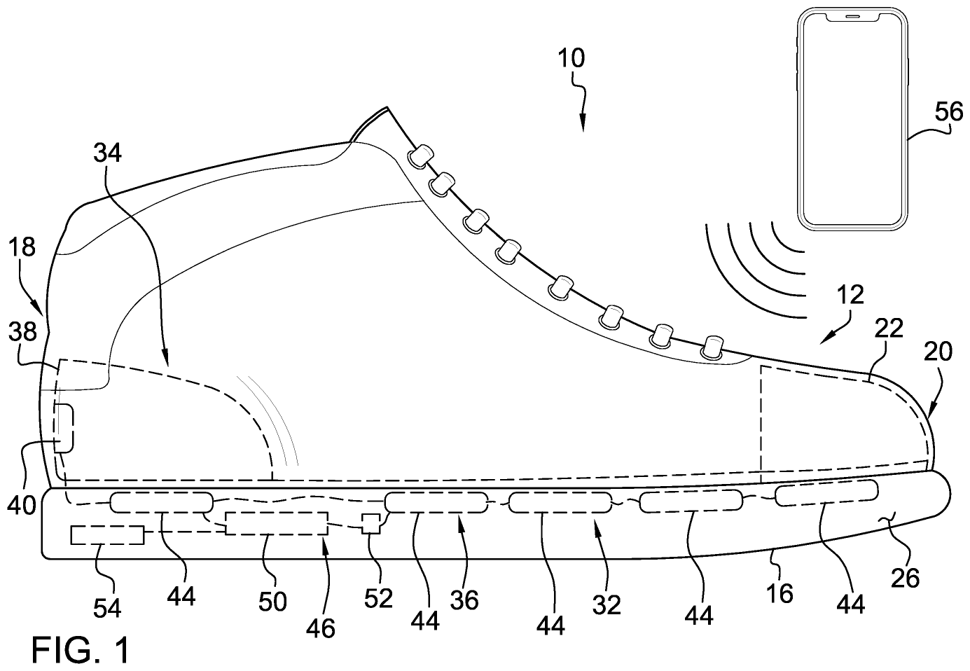

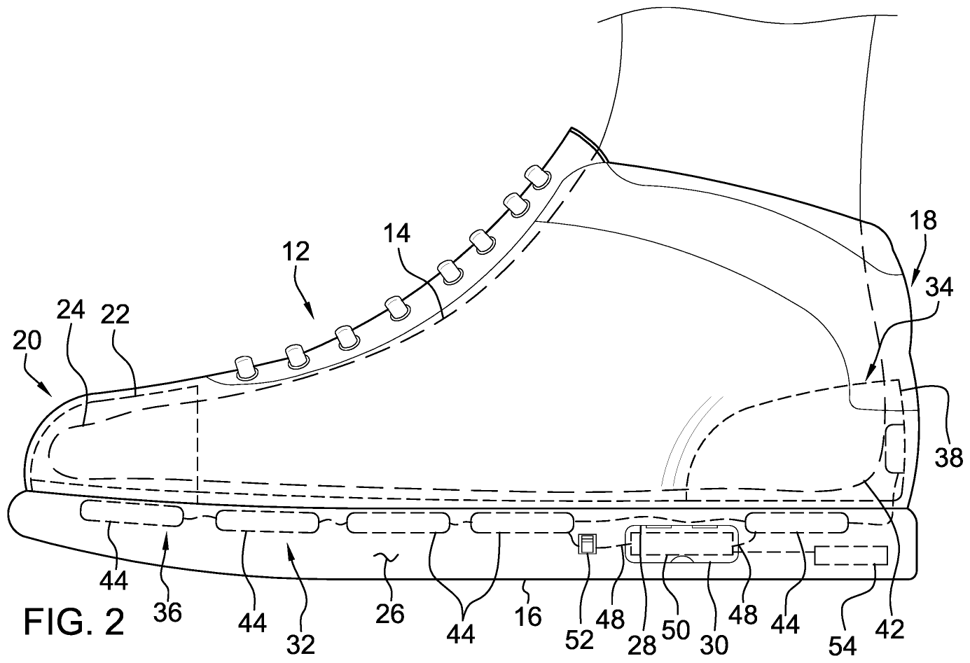

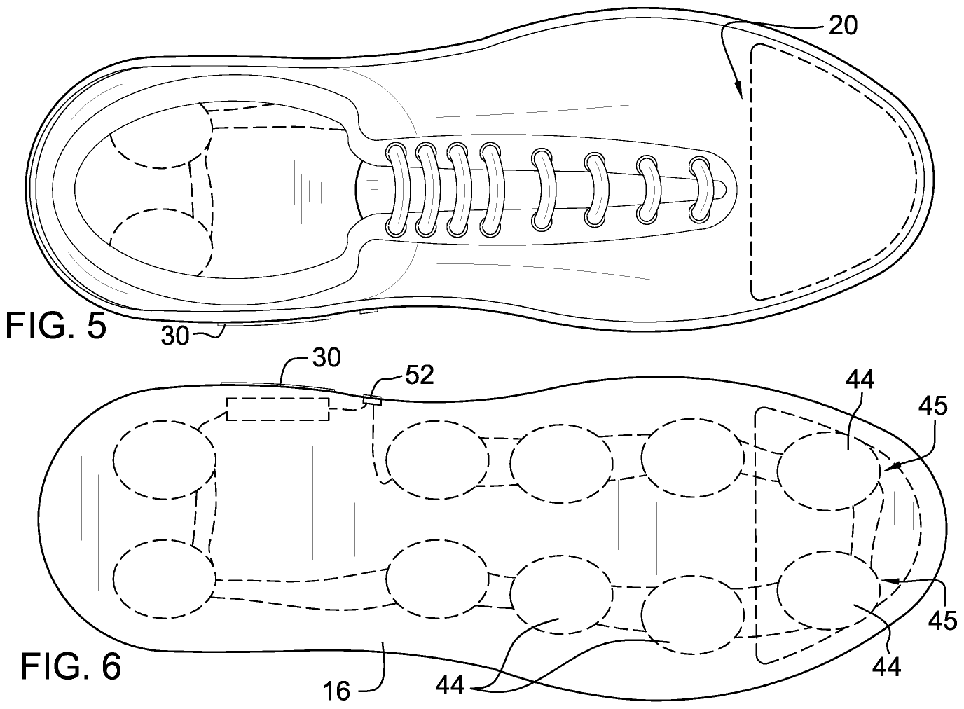

With reference now to the drawings, and in particular to FIGS. 1 through 6 thereof, a new safety shoe device embodying the principles and concepts of an embodiment of the disclosure and generally designated by the reference numeral 10 will be described.

As best illustrated in FIGS. 1 through 6, the therapeutic safety shoe assembly 10 generally comprises a shoe 12 that is wearable on a user's foot 14. The shoe 12 has a sole 16, a heel 18 and a toe 20, and the shoe 12 has a shield 22 which is integrated into the toe 20. The shield 22 is comprised of a rigid material, such as steel or the like, to protect the user's toes 24 from impact when the shoe 12 is worn. The sole 16 has an outer surface 26 and the outer surface 26 has a power supply well 28 extending into an interior of the sole 16. A battery cover 30 is removably attachable to the outer surface 26 of the sole 16 and the battery cover 30 is aligned with the power supply well 28 for closing the power supply well 28. The shoe 12 may be a work boot or other type of shoe 12 that would commonly be worn in an industrial environment, for example, or other environment that would require personal protective equipment in the form of steel toed boots.

A vibration unit 32 is integrated into the shoe 12 and the vibration unit 32 vibrates the shoe 12 when the vibration unit 32 is turned on. In this way the vibration unit 32 can massage the user's foot 14 when the shoe 12 is being worn. The vibration unit 32 includes a heel element 34 that is integrated into the heel 18 of the shoe 12 and the vibration unit 32 includes a sole element 36 which is integrated into the sole 16 of the shoe 12. The heel element 34 comprises a cup 38 extending around the heel 18 of the shoe 12 and the cup 38 is comprised of a rigid material. The vibration unit 32 includes a heel vibrator 40 that is coupled to the cup 38 such that the heel vibrator 40 is in mechanical communication with the cup 38. Furthermore, the heel vibrator 40 vibrates the cup 38 when the heel vibrator 40 is turned on to massage the user's heel 42 for enhancing comfort for the user.

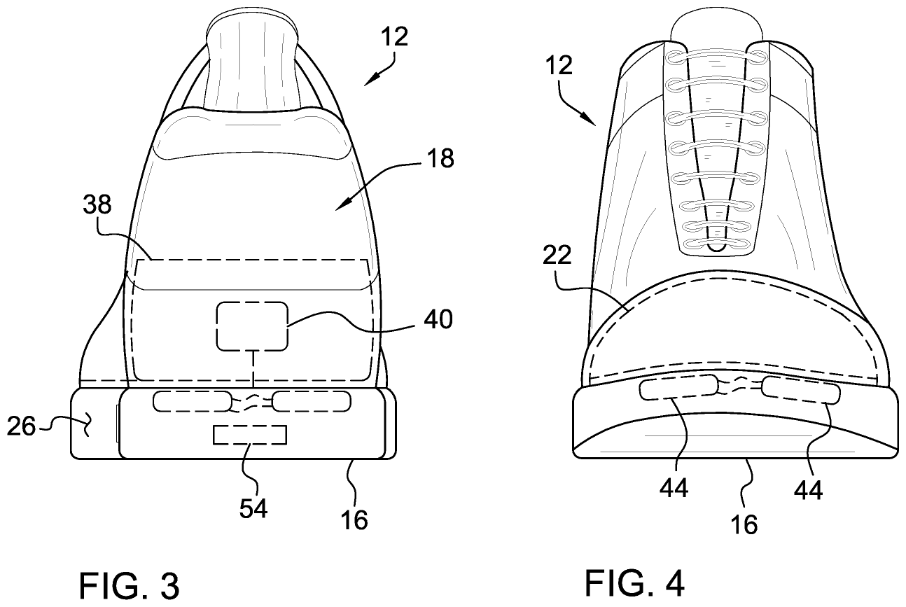

The sole element 36 comprises a plurality of vibration motors 44 and each of the vibration motors 44 is integrated into the sole 16 such that each of the vibration motors 44 is in mechanical communication with the sole 16. The vibration motors 44 are spaced apart from each other and are distributed between the heel 18 of the shoe 12 and the toe 20 of the shoe 12. As is most clearly shown in FIGS. 3, 4 and 6, the plurality of vibration motors 44 may be arranged in a pair of rows 45. Additionally, the plurality of vibration motors 44 is electrically coupled to each other.

The plurality of vibration motors 44 vibrates the sole 16 when the plurality of vibration motors 44 is turned on. In this way the plurality of vibration motors 44 massage the sole of the user's foot 14 for enhancing comfort for the user. Each of the vibration motors 44 may comprise an electric motor and a cam being rotated by the electric motor. Additionally, the heel vibrator 40 may comprise an electric motor and a vibration device being driven by the electric motor associated with the heel vibrator 40.

A power supply 46 is integrated into the sole 16 of the shoe 12 and the power supply 46 is electrically coupled to the vibration unit 32. The power supply 46 comprises a plurality of contacts 48 that is each integrated into the power supply well 28 in the outer surface 26 of the sole 16. Additionally, each of the contacts 48 is electrically coupled to the vibration unit 32. The power supply 46 includes a battery 50 that is removably positioned in the power supply well 28. The battery 50 is in electrical communication with the contacts 48 when the battery 50 is positioned in the power supply well 28. The power supply 46 includes a power switch 52 that is slidably integrated into the outer surface 26 of the sole 16 such that the power switch 52 is accessible to the user. The power switch 52 is electrically coupled to the plurality of vibration motors 44 and the heel vibrator 40 for actuating or de-actuating each of the vibration motors 44 and the heel vibrator 40.

A receiver 54 is integrated into the shoe 12 and the receiver 54 is electrically coupled to each of the vibration motors 44 and the heel vibrator 40. Each of vibration motors 44 and the heel vibrator 40 is turned on when the power switch 52 is turned on and the receiver 54 receives an actuate command. Furthermore, the receiver 54 is in wireless communication with a personal electronic device 56 to facilitate the user to remotely control the vibration motors 44 and the heel vibrator 40. The receiver 54 may comprise a radio frequency receiver or the like and the receiver 54 may employ Bluetooth communication protocols. Additionally, the personal electronic device 56 may comprise a smart phone or other similar device with wireless communication capabilities. The personal electronic device 56 may store operational software comprising a smart phone app for remotely controlling the vibration unit 32.

In use, the personal electronic device 56 is synched with the receiver 54 and the shoe 12 is worn. The vibration unit 32 can be remotely controlled with the personal electronic device 56. In this way the user can enjoy a therapeutic foot massage while the user is wearing the shoe 12. Thus, a worker in an industrial environment, for example, can enjoy relief from foot fatigue and other physical discomfort that commonly results from standing for extended periods of time. The shoe 12 can be worn in the convention of personal protective equipment regardless of whether the vibration unit 32 is turned on or off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A therapeutic safety shoe assembly for massaging a user's feet while being worn on the user's feet, said assembly comprising:
a shoe being wearable on a user's foot, said shoe having a sole, a heel and a toe, said shoe having a shield being integrated into said toe; and
a vibration unit being integrated into said shoe, said vibration unit vibration said shoe when said vibration unit is turned on wherein said vibration unit is configured to massage the user's foot when said shoe is being worn, said vibration unit including a heel element being integrated into said heel of said shoe, said vibration unit including a sole element being integrated into said sole of said shoe.

2. The assembly according to claim 1, wherein:
said sole has an outer surface, said outer surface having a power supply well extending into an interior of said sole; and
said assembly includes a battery cover being removably attachable to said outer surface of said sole, said battery cover being aligned with said power supply well for closing said power supply well;

3. The assembly according to claim 1, wherein said heel element comprises:
a cup extending around said heel of said shoe, said cup being comprised of a rigid material; and
a heel vibrator being coupled to said cup such that said heel vibrator is in mechanical communication with said cup, said heel vibrator vibrating said cup when said heel vibrator is turned on wherein said cup is configured to massage the user's heel for enhancing comfort for the user.

4. The assembly according to claim 1, wherein said sole element comprises a plurality of vibration motors, each of said vibration motors being integrated into said sole such that each of said vibration motors is in mechanical communication with said sole, said vibration motors being spaced apart from each other and being distributed between said heel of said shoe and said toe of said shoe, said plurality of vibration motors being electrically coupled to each other, said plurality of vibration motors vibrating said sole when said plurality of vibration motors is turned on wherein said plurality of vibration motors is configured to massage the sole of the user's foot for enhancing comfort for the user.

5. The assembly according to claim 1, wherein:
said vibration unit includes a plurality of vibration motors and a heel vibrator; and
said assembly includes a power supply being integrated into said sole of said shoe, said power supply being electrically coupled to said vibration unit, said power supply comprising:
a plurality of contacts, each of said contacts being integrated into said power supply well in said outer surface of said sole, each of said contacts being electrically coupled to said vibration unit;
a battery being removably positioned in said power supply well, said battery being in electrical communication with said contacts when said battery is positioned in said power supply well; and
a power switch being slidably integrated into said outer surface of said sole wherein said power switch is configured to be accessible to the user, said power switch being electrically coupled to said plurality of vibration motors and said heel vibrator for actuating or de-actuating each of said vibration motors and said heel vibrator.

6. A therapeutic safety shoe assembly for massaging a user's feet while being worn on the user's feet, said assembly comprising:
a shoe being wearable on a user's foot, said shoe having a sole, a heel and a toe, said shoe having a shield being integrated into said toe, said shield being comprised of a rigid material wherein said shield is configured to protect the user's toes from impact when said shoe is worn, said sole having an outer surface, said outer surface having a power supply well extending into an interior of said sole;
a battery cover being removably attachable to said outer surface of said sole, said battery cover being aligned with said power supply well for closing said power supply well;
a vibration unit being integrated into said shoe, said vibration unit vibration said shoe when said vibration unit is turned on wherein said vibration unit is configured to massage the user's foot when said shoe is being worn, said vibration unit including a heel element being integrated into said heel of said shoe, said vibration unit including a sole element being integrated into said sole of said shoe, said heel element comprising:
a cup extending around said heel of said shoe, said cup being comprised of a rigid material; and
a heel vibrator being coupled to said cup such that said heel vibrator is in mechanical communication with said cup, said heel vibrator vibrating said cup when said heel vibrator is turned on wherein said cup is configured to massage the user's heel for enhancing comfort for the user;
wherein said sole element comprises a plurality of vibration motors, each of said vibration motors being integrated into said sole such that each of said vibration motors is in mechanical communication with said sole, said vibration motors being spaced apart from each other and being distributed between said heel of said shoe and said toe of said shoe, said plurality of vibration motors being electrically coupled to each other, said plurality of vibration motors vibrating said sole when said plurality of vibration motors is turned on wherein said plurality of vibration motors is configured to massage the sole of the user's foot for enhancing comfort for the user;
a power supply being integrated into said sole of said shoe, said power supply being electrically coupled to said vibration unit, said power supply comprising:
a plurality of contacts, each of said contacts being integrated into said power supply well in said outer surface of said sole, each of said contacts being electrically coupled to said vibration unit;
a battery being removably positioned in said power supply well, said battery being in electrical communication with said contacts when said battery is positioned in said power supply well; and
a power switch being slidably integrated into said outer surface of said sole wherein said power switch is configured to be accessible to the user, said power switch being electrically coupled to said plurality of vibration motors and said heel vibrator for actuating or de-actuating each of said vibration motors and said heel vibrator; and
a receiver being integrated into said shoe, said receiver being electrically coupled to each of said vibration motors and said heel vibrator, each of vibration motors and said heel vibrator being turned on when said power switch is turned on and said receiver receives an actuate command, said receiver being in wireless communication with a personal electronic device wherein said receiver is configured to facilitate the user to remotely control said vibration motors and said heel vibrator.
